(19) United States
(12) Patent Application Publication
(10) Pub. No.: US 2003/0133241 A1
(43) Pub. Date: Jul. 17, 2003

(54) Method and arrangement for protecting digital parts of circuits

(76) Inventors: Markus Feuser, Hamburg (DE); Ralf Malzahn, Seevetal (DE)

Correspondence Address: PHILIPS ELECTRONICS NORTH AMERICAN CORP, 580 WHITE PLAINS RD, TARRYTOWN, NY, 10591, US

(21) Appl. No.: 10/324,767

(22) Filed: Dec. 20, 2002

(30) Foreign Application Priority Data
Dec. 29, 2001 (DE) 10164419.1

(51) Int. Cl. H02H 3/24

(52) U.S. Cl. 361/92

(57) ABSTRACT

The invention relates to a method and an arrangement for protecting digital parts of circuits, which method and arrangement may be used in particular to protect memory units in such digital circuits, and particularly in smart-card controllers, that contain secret data, against attacks in which the approach adopted is to change digital parts of circuits, and particularly the digital part of a smart-card controller, to an undefined state by brief voltage drops, e.g. by light-flash attacks.

The invention relates to a method and an arrangement for protecting digital parts of circuits, which method and arrangement may be used in particular to protect memory units containing secret data in such digital circuits, and particularly in smart-card controllers, against attacks in which the approach adopted is to change digital parts of circuits, and particularly the digital part of a smart-card controller, to an undefined state by means of brief voltage drops, e.g. by light-flash attacks.

The development of microelectronics in the seventies made it possible for miniature computers of credit card format with no user interface to be produced. Computers of this kind are referred to as smart cards. In a smart card, a data memory and an arithmetic and logic unit are integrated into a single chip measuring a few square millimeters in size. Smart cards are used in particular as telephone cards and GSM SIM cards and in the banking field and in health care. The smart card has thus become a computing platform that we see wherever we turn.

Smart cards are currently regarded primarily as a safe and secure place for holding secret data and as a safe and secure platform for running cryptographic algorithms. The reason why the data and algorithms on the card are assumed to enjoy relatively high safety and security lies in the hardware construction of the card and in the interfaces that are run to the exterior. From the outside the card looks like a “black box”, whose functions can only be accessed via a well-defined hardware and software interface and which can compel the observance of certain security policies. On the one hand, access to data can be linked to certain conditions. Access from outside to critical data, such as secret keys in a public key process for example, may even be totally barred. On the other hand a smart card is capable of running algorithms without it being possible for the execution of the individual operations to be observed from outside. The algorithms themselves may be protected on the card against being altered or read out. In an object-orientated sense, the smart card can be thought of as a type of abstract data that has a well-defined interface, that behaves in a specified way and that is itself capable of ensuring that certain integrity conditions are observed with regard to its state.

Essentially, there are two different types of smart card. Memory cards have simply a serial interface, addressing and security logic and ROM and EEPROM memories. Such cards perform only limited functions and are used for a specific application. This is why they are particularly cheap to produce. Smart cards produced in the form of microprocessor cards constitute, in principle, a complete general-purpose computer.

The process of manufacturing and supplying chip cards can be divided into the following phases:

production of the chip,

embedding of the chip,

printing of the card

personalization of the card

issue of the card.

Each phase of the process is generally carried out by a company specializing in the particular operation. When the chips are being produced, care must be taken to ensure good security within the firm, particularly when the cards involved have hard-wired security logic. To enable the manufacturer to carry out a proper final test, the entire memory has to be freely accessible. Only after the final test is the chip made secure by means of a transport code. Thereafter, access to the card memory is possible only for authorized bodies that know the transport code. Hence there is no point in stealing brand-new chips. The authorized bodies may be card personalizers or issuers. No further safeguarding functions are required for the embedding and printing operations. There is no need for the firms involved to know the transport code.

It is generally not the card manufacturer but the issuing body (e.g. a bank, telephone company, private or public health-care scheme) that puts the personal data into the card. This process is known as personalization and to perform it it is necessary to know the transport code.

The issue of the card, i.e. its movement from the issuing body to the cardholder, poses another security problem. To be exact, it is only the issue of the card to the card holder in person in return for a signature and production of an identity card or other personal identification that is secure. It is true that sending out by post is often cheaper, but it is also not very secure. Another problem is notifying the cardholder of the PIN number, in which case the same care has to be taken as with the card.

Because of the potentially dangerous security-related information held in the memories present in smart card controllers, not only do the above safeguarding steps have to be taken but additional protection also needs to be provided against the possible activities of hackers, which may cover every phase of the life of a smart card beginning with the manufacture of the card and extending through its transport and use to the manipulation of cards that have become unusable.

The area to which the greatest effort is devoted to provide protection against data and programs on data carriers, e.g. chips on chip cards, being illicitly detected is the encryption of the data; there are no, or only minimal, safeguards against illicit access to the chip. In the case of a chip card, physical access can generally be gained to the data, or in other words it can be extracted, by first removing the layer of plastic by chemical means and then using a probing needle inserted through any passivating covering there may be over the chip. Another approach that is adopted in certain attacks by hackers is to change the digital part of a smart-card controller to an undefined state. Brief voltage drops are provoked for this purpose, e.g. by light-flash attacks.

A method and arrangement for protecting electronic computing units against unwanted access are described in WO 98/18102. In this case the side of the computing unit that is exposed to attack is provided with a casing having non-homogeneous properties. The computing unit makes measurements at one or more points on the casing once signals defined by the computing unit have been applied at a specified signal input point on the casing. The measurements made in this way are used to form a signature, which is stored in a register. Because any injury or damage changes the special properties of the casing, the measurement made after an injury produces a different signature than that which was stored in the register for the unharmed casing. When this is the case, comparison of the signatures produces an error message and causes other steps intended for dealing with such an eventuality to be taken.

A method of preventing the unauthorized running of security-related programs in, for example, smart cards is described in U.S. Pat. No. 5,682,031. When this method is applied, a plurality of copies of a logic lock written in the EPROM of the smart card are made and are stored at different storage locations in the EPROM and are gated together by an OR logic. It is true that safeguarding by this method prevents the unauthorized running of the safety-related programs that are protected in this way when they are blocked. What there is no guarantee of however is that this protection will be effective if the smart-card controller is in an undefined state.

U.S. Pat. No. 5,465,349 describes a safeguarding method for monitoring integrated circuits for undefined states; what is done for this purpose is, firstly before each transmission of data to an outside device and secondly before each change (reading or writing) of memory data in the integrated circuit, which is generally stored in an EPROM or EEPROM, that a status enquiry is made to one or more security registers. The status of the security registers is changed if the system finds an undefined state, and sensors, e.g. a sensor that monitors the operating frequency of the circuits, or an optical sensor, may also be used for this purpose.

In U.S. Pat. No. 6,092,147 is described a distributed check on non-hardware-dependent, executable byte code that is transmitted from a computing system to a virtual machine to be run there. In the check, the byte code is compared with preset criteria; the check that is made in this case takes place as follows. The check on the transmitting computing system having been completed, the result of the check is first confirmed by the virtual machine before the byte code is run on the latter.

In a method that is specified in U.S. Pat. No. 6,249,872, protection against illicit access to protected memories in an electronic system, and particularly a computer system, is improved by carrying out the following steps: setting the computer system to a mode of operation in which a confirmation process is carried out; then, before exiting this mode of operation, setting a security circuit to a first preset status; then making a check on the status of the security circuit, in which case the operations performed by the computer system are stopped if the status of the security circuit is other than that preset.

The sensor arrangements on smart-card controllers are usually based on analog circuitry. Nowadays, circuit parts of analog design of this kind (e.g. voltage, light, and temperature sensors) have to be kept separate by so-called glue logic. The reasons why this has to be done are these:

Sensitivity to interference—Closely adjacent digital parts of the circuits cause interference for the sensitive sensors.

Circuit components—It is not only standard NMOS and PMOS transistors that are used in analog circuits but also specially sized transistors, capacitors and resistors. Due to their size these will not fit into the preset grid for the standard cells.

The result of this is that specialists are able to locate the sensor arrangements. What is more, by using special devices (e.g. with a focused ion beam (FIB)) it is possible to switch off the sensors once they have been located.

Sensitive parts of circuits can of course be protected by a special layout but this means a great deal of cost and complication, which is normal nowadays in the case of smart-card controllers. Sometimes an experienced hacker can still perform manipulations.

It is therefore an object of the invention to specify a method and an arrangement of the generic kind by which the disadvantages of the conventional protective measures are overcome and, in particular, secret data stored in a digital part of a circuit is prevented from becoming accessible once this digital part of the circuit has been successfully changed to an undefined state.

In accordance with the invention, this object is achieved by means of a collaborative association of the features in the characterizing clauses of claims 1 and 6 with the features in the preambles. Advantageous embodiments of the invention are detailed in the subclaims.

A special advantage of the method of protecting digital parts of circuits is that voltage drops are detected.

An arrangement for protecting digital parts of circuits is advantageously so constructed that the digital part of the circuit (the glue logic) comprises at least one digital sensor 1.

A further advantage of the method according to the invention is that the voltage drops within the glue logic are detected. The method according to the invention can be used in particular to detect voltage drops within a smart-card controller.

In another preferred application of the method according to the invention, provision is made for the voltage drops to be detected by digital sensors.

It has also proved advantageous if, in the method according to the invention, the sensors are activated by the reset signal being set to logic zero.

In a preferred embodiment of the arrangement according to the invention, provision is made, when there is a plurality of sensors present, for the sensors to be gated together by an OR circuit.

Another preferred embodiment of the arrangement according to the invention is distinguished by the fact that the sensor(s) is (are) in the form of a special cell that comprises a NOR gate, an inverter and a capacitor.

It is also advantageous for the NOR gate and inverter to be connected as a latch. As well as this, provision is made in a preferred embodiment of the invention for the standard cell(s) to have a NOR gate and an inverter, in which case the input of the NOR gate is connected to the output of the inverter and, via a capacitor, to the supply voltage and the input of the inverter is connected to the output of the NOR gate and the reset signal can be applied to the input of the NOR gate and the error signal can be picked off from the output of the NOR gate.

It is also found to be an advantage for the threshold voltages of the transistors used in the NOR gate and the inverter to be arranged to be different. A further advantage lies in the sensor(s) being in the form of a light or voltage sensor or sensors. In a preferred embodiment of the arrangement according to the invention, provision is made for the so-called glue logic to be part of a smart-card controller.

A special sensor arrangement distributed over the digital part (the glue logic) provides protection against the attacks mentioned. Because the sensors are situated within the glue logic, the following advantage is achieved. Firstly, the sensors are able to detect voltage drops at the point where they are most critical. Secondly the sensors are no longer recognizable as such.

The security of the chip as a whole is appreciably increased. Attacks on the glue logic itself, e.g. in the form of light-flash attacks, are at once detected on the spot. Also, the sensors are very small, as a result of which quite a large number of instances can be distributed over the glue logic without the need to waste very much of the area of the chip. The sensors cannot be recognized as such or distinguished from the standard cells.

These and other aspects of the invention are apparent from and will be elucidated with reference to the embodiment described hereinafter.

In the drawings:

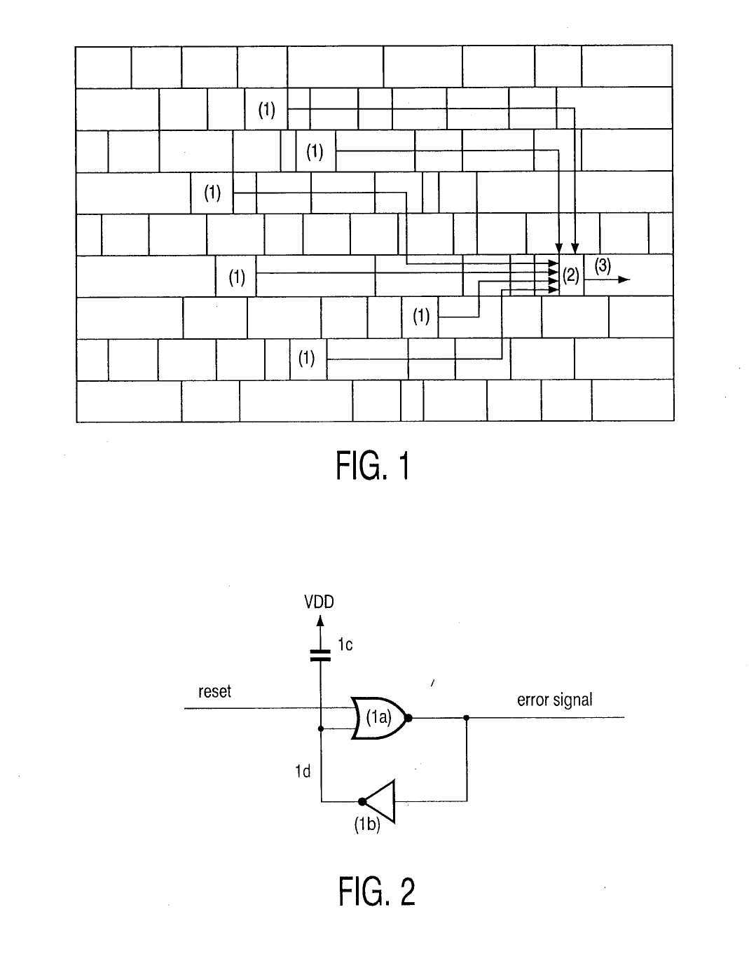

FIG. 1 shows a distribution for the special standard cells forming sensors in a digital part.

FIG. 2 shows the makeup of a sensor constructed as a standard cell.

The digital part shown in FIG. 1 is described in what follows. The output signals from standard cells 1 operating as sensors are gated together by an OR circuit 2. A final output signal 3 from the OR circuit 2 is active when one or more sensors 1 supply an error signal.

The illustrative arrangement that is shown in FIG. 2 for a sensor 1 constructed as a standard cell comprises a NOR gate 1a and an inverter 1b; these operate as a latch. A node 1d, at which an input of NOR gate 1a is connected to the output of inverter 1b, is connected via a capacitor 1c to a supply voltage VDD. The input of inverter 1b is connected to the output of NOR gate 1a. A reset signal can be applied to a further input of NOR gate 1a and an error signal to be supplied by the sensor 1 can be picked off from the output of NOR gate 1a.

The latch comprising NOR gate 1a and inverter 1b can be reset by the reset signal in such a way that the error signal emitted by sensor 1 becomes inactive and goes to the logic “0” state. In this state, the node 1d is at logic “1”.

As soon as the reset signal changes to logic “0”, the sensor 1 is “live”. Voltage drops affecting the supply voltage VDD pass through the capacitor 1c, and as a result there is a brief voltage drop at node 1d. Due to a special property of the latch made up of 1a and 1b, this voltage drop results in the latch changing over and in the error signal changing to logic “1”. This state remains stored until the next reset pulse.

The above special property is obtained by, for example asymmetry, by arranging the threshold voltages of the transistors used in gates 1a and 1b to be different. This gives the latch a preferred direction that corresponds to the error state.

The invention is not limited to the embodiments shown and described here. By combining and modifying the means and features mentioned it is in fact possible to produce other variant embodiments without thereby exceeding the scope of the invention.

List of Reference Numerals

1 Standard cell operating as sensor

1a NOR gate

1b Inverter

1c Capacitor

1d Node

2 OR circuit

3 Output signal

1. A method of protecting digital parts of circuits, characterized in that voltage drops are detected.

2. A method as claimed in claim 1, characterized in that the voltage drops are detected within at least one of the digital parts of the circuit (that are referred to as glue logic).

3. A method as claimed in either one of the foregoing claims, characterized in that the voltage drops are detected within a smart-card controller.

4. A method as claimed in any one of the foregoing claims, characterized in that the voltage drops are detected by digital sensors.

5. A method as claimed in any one of the foregoing claims, characterized in that the sensors are activated by setting the reset signal to logic zero.

6. An arrangement for protecting digital parts of circuits, characterized in that the digital part of the circuit (the glue logic) comprises at least one digital sensor (1).

7. An arrangement as claimed in claim 6, characterized in that, when there are a plurality of sensors (1) present, they are gated together by an OR circuit (2).

8. An arrangement as claimed in either one of claims 6 and 7, characterized in that the sensor(s) (1) is (are) in the form of a special standard cell that comprises a NOR gate (1a), an inverter (1b) and a capacitor (1c).

9. An arrangement as claimed in claim 8, characterized in that the NOR gate (1a) and the inverter (1b) are connected as a latch.

10. An arrangement as claimed in claim 8, characterized in that the standard cell(s) (1) has (have) a NOR gate (1a) and an inverter (1b), an input of the NOR gate (1a) being connected to the output of the inverter (1b) and, via a capacitor (1c), to a supply voltage (VDD) and the input of the inverter (1b) being connected to the output of the NOR gate (1a) and the reset signal being able to be applied to a further input of the NOR gate (1a) and an error signal being able to be picked off from the output of the NOR gate (1a).

11. An arrangement as claimed in any one of claims 8 to 10, characterized in that threshold voltages of the transistors used in the NOR gate (1a) and the inverter (1b) are arranged to be different.

12. An arrangement as claimed in any one of claims 6 to 11, characterized in that the sensor(s) (1) is (are) in the form of a light or voltage sensor or sensors.

13. An arrangement as claimed in any one of claims 6 to 12, characterized in that the glue logic is part of a smart-card controller.
